(19) United States
(12) Patent Application Publication
(10) Pub. No.: US 2012/0298820 A1
(43) Pub. Date: Nov. 29, 2012

(54) SURGICAL TOOL HOLDER

(76) Inventor: Spiros MANOLIDIS, New York, NY (US)

(21) Appl. No.: 13/115,791

(22) Filed: May 25, 2011

(51) Int. Cl. F16M 13/02

(52) U.S. Cl. 248/222.14; 248/220.21

(57) ABSTRACT

Apparatuses are provided to hold surgical tools during surgery. Such apparatuses may be fixed to a patient's body and include a base member, tool engagement member and one or more intermediary members. Each member may be attached to another by a knob and mating engagement section. Fixation between members may be provided individually for each attachment or may be provided so as to fix more than one attachment at a time.

### TECHNICAL FIELD

This disclosure relates to a device and apparatus for holding surgical tools during surgery. In particular, a surgical tool holder attaches to a patient's bone, for example, the skull, during surgery, and is comprised of one or more individually lockable linkages.

### DESCRIPTION OF RELATED ART

In many types of surgeries, surgical tools are held in a fixed or near fixed position relative to the surgical site for long periods of time. Common surgical tools needing to be held relatively still with respect to the surgical site include retractors, vacuum devices, clamping tools, etc. Sometimes, surgical assistants are employed to hold the tools in place, whereas other times, surgical tool holding devices may be used for this purpose. In surgeries requiring that tools be held for very long periods of time, when a tool is required to be rigidly fixed, when a tool is required to be precisely positioned, etc. a surgical tool holding device is favored.

As one example, tool holding devices are often used in neurosurgery. Neurosurgery typically involves long operating times and very often requires the precise and rigid placement of tools throughout the surgery. For example, retractors, spatulas, etc. are common tools used in neurosurgery which enter a hole opened in a patient's skull and are positioned to spread brain tissue to provide visual and physical access to a surgical site located at some depth within the brain. Such tools must be held stably and precisely throughout the neurosurgical procedure.

Conventional surgical tool holding devices fall primarily into two categories. One category of holding devices are fixed at their base (non-tool end) to something other than the patient, such as an operating table, the floor or ceiling of the operating room, etc. The other category of surgical tool holders are fixed at their base directly to the patient's body, such as, for example, the skull, during surgery. In addition, conventional holding devices may be attached to both the patient's body and something other than the patient, such as an operating table, the floor or ceiling of the operating room, etc. Each category has its advantages and disadvantages. For example, patient-fixed devices have the benefit that if the patient is moved during surgery, the position of the tool may remain fairly constant with relation to the surgical site. As another example, non-patient-fixed tool holders are typically less invasive to the patient, usually resulting in a faster post-surgery healing time or less post-surgery pain. However, non-patient-fixed tool holders have the drawback that care must be taken that a patient is not moved during surgery.

In both categories, a generally available feature among conventional tool holders is the ability to position a tool holder end as desired and the ability to fix the tool holder in the desired position during surgery. Many approaches have been proposed to offer these capabilities.

An example of one popular approach is shown in the conventional snake-type tool holder proposed in U.S. Pat. No. 3,858,578 to Milo which is incorporated by reference herein in its entirety. Such example generally employs a series of link members (20) having a spherically convex end (22), a spherically concave end (24) and a hole throughout (28). The link members are nested in one another (i.e. a convex end rests in a neighboring concave end) and a wire or cable (D) is threaded through the holes in each of the link members. The wire typically is fixed to the last link member in the chain or an end of the wire is at least prevented from being pulled through the last link member. A tensioner typically acts on the last link member at the other end of the chain to tension the cable, compressing the link members together. Friction between each of the link members' contacting surfaces holds the link members relatively rigid with respect to one another. A tool engaging member may be attached to one end of the chain and a base fixation member may be attached to the other end of the chain. However, such conventional device has many drawbacks, such as its susceptibility to premature wear, a significant sensitivity to liquids or debris between link members, a possibility of complete failure if the internal cable snaps, stretches, or comes loose at either end, etc. Moreover, such conventional devices may not provide the level of rigidity required for high-precision surgeries.

Several approaches have similarly been proposed for fixing a base of a surgical tool holder to a patient. Surgeries in which such patient-fixation is important include neurosurgery, some types of orthopedic surgeries, back surgeries, etc. Generally such patient-fixation type holders are employed when a high degree of precision is required and when the consequences of a held tool shifting position relative to a patient during surgery may be problematic or catastrophic.

In one conventional approach for neurosurgery, illustrated in U.S. Pat. No. 5,269,034 to Day, et al., which is incorporated by reference herein in its entirety, a surgical head clamp comprises three sharp pins (22, 30, 32) which puncture a patient's skin and penetrate some depth into a patient's skull to hold the head clamp in place relative to the skull during surgery. The halo connecting the three sharp pins (22, 30, 32) serves as a relatively stationary base for one or more tool holders, instruments, etc., which may be attached thereto. However, because the pin attachment method is not completely sterile, a surgical drape must be used over the halo, with any tools entering the surgical field through an opening in the drape. Such arrangement impairs visual and physical access to the surgical site.

In another conventional approach for neurosurgery, shown in U.S. Pat. No. 4,457,300 to Budde which is incorporated by reference herein in its entirety, a clip is slipped between the inside of a patient's skull and the patients' brain at the edge of an opening in the skull made in preparation for the surgery. A screw on the outside of the patient's skull acting against the clip serves to clamp a halo to the patient's skull. The halo again serves as a base for one or more tool holders, instruments, etc. which may be attached thereto.

However, with each of these conventional approaches, great care is needed to align and fit the halo, clamps, points, etc. to a patient's skull. Such set-up often requires the aid of two or more people in the operating room and can be very cumbersome and may take a significant amount of time to complete. In addition, a patient is subjected to jostling during the set-up and the invasive nature of such fixation approaches can increase the risk of infection, neuropraxia from nerve impingement, bleeding from puncture of arterial supply to the scalp, increased post-surgery pain or increased healing time.

Thus, there exists a need for a surgical tool holding device which has improved rigidity, ease of set-up and is minimally invasive to a patient.

### SUMMARY

This disclosure provides apparatuses for holding surgical tools during surgery.

In an aspect, a surgical tool holder includes a base member for attaching to a patient's body, a tool engagement member for engagement with a surgical tool and one or more flexibly connected intermediary members. Attachment between the various members may be provided by link attachment knobs and corresponding or mating knob engagement sections of the various intermediary members. Knob engagement sections may include a first knob contacting surface and a second knob contacting surface and a fixing means for biasing the first knob contacting surface towards the second knob contacting surface when the knob contacting surfaces are in engagement with a link attachment knob. An intermediary link clamp member may include a first and second knob engagement sections at either end.

In another aspect, fixing means for the first knob engagement section and the second knob engagement section may be independent, allowing for independent fixation of the first knob engagement section and the second knob engagement section.

In still another aspect, the first knob engagement section and the second knob engagement section may be fixed in concert through a shared fixing means.

In yet another aspect, a link clamp member may include a first link clamp component and a second link clamp component, the first knob contacting surfaces of the first and second knob engagement sections being provided on the first clamp component and the second knob contacting sections being provided on the second clamp component. A shared fixing means biases the first clamp component towards the second clamp component to fix both knob engagement sections simultaneously and to hold the link attachment knob in place.

### BRIEF DESCRIPTION OF THE DRAWINGS

The above mentioned and other aspects, features and advantages can be more readily understood from the following detailed description with reference to the accompanying drawings wherein:

FIG. 1 shows a perspective view of a surgical tool holder according to an exemplary embodiment of the present disclosure;

FIG. 1a shows a side view of a link clamp member according to an exemplary embodiment of the present disclosure;

FIG. 1b shows a partial cross section view of a link clamp member according to an exemplary embodiment of the present disclosure;

FIG. 2 shows a perspective view of a surgical tool holder in use according to another exemplary embodiment of the present disclosure;

FIG. 3 shows a cross sectional detail view of a base member and knob engagement section according to yet another exemplary embodiment of the present disclosure;

FIG. 3a shows a cross sectional detail view of a base member and knob engagement section according to yet another exemplary embodiment of the present disclosure;

FIG. 4 shows a perspective view of a base member according to another exemplary embodiment of the present disclosure;

FIG. 5 shows a perspective view of a base member according to another exemplary embodiment of the present disclosure;

FIG. 5a shows a detail perspective view of a base member and link clamp member according to another exemplary embodiment of the present disclosure;

FIG. 5b shows a detail cross sectional view of a base member and link clamp member according to another exemplary embodiment of the present disclosure;

FIG. 6 shows a side view of a base member and a link clamp member according to another exemplary embodiment of the present disclosure;

FIG. 6a shows a perspective cross sectional detail view of a base member and link clamp member according to an exemplary embodiment of the present disclosure;

FIG. 7 shows a side view of an intermediary member according to still an exemplary embodiment of the present disclosure;

FIG. 8 shows a perspective view of a portion of a surgical tool holder according to an another exemplary embodiment of the present disclosure;

FIG. 8a shows a side view of a knob screw according to an exemplary embodiment of the present disclosure;

FIG. 9 shows a perspective view of a surgical tool holder according to yet another exemplary embodiment of the present disclosure;

FIG. 10 shows a side view of an intermediary member according to another exemplary embodiment of the present disclosure;

FIG. 11 shows a perspective view of a base member according to yet another exemplary embodiment of the present disclosure;

FIG. 12 shows a perspective view of a base member according to still another exemplary embodiment of the present disclosure;

FIG. 13 shows a perspective view of a surgical tool holder in use according to another exemplary embodiment of the present disclosure;

FIG. 13a shows a cross sectional detail view of a base member and knob engagement section according to yet another exemplary embodiment of the present disclosure; and

FIG. 14 shows a perspective view of a base member according to yet another exemplary embodiment of the present disclosure.

### DETAILED DESCRIPTION

Devices and apparatuses for holding surgical tools during surgery are described herein, with reference to examples and exemplary embodiments. Specific terminology is employed in describing examples and exemplary embodiments. However, the disclosure of this patent specification is not intended to be limited to the specific terminology so selected and it is to be understood that each specific element includes all technical equivalents that operate in a similar manner.

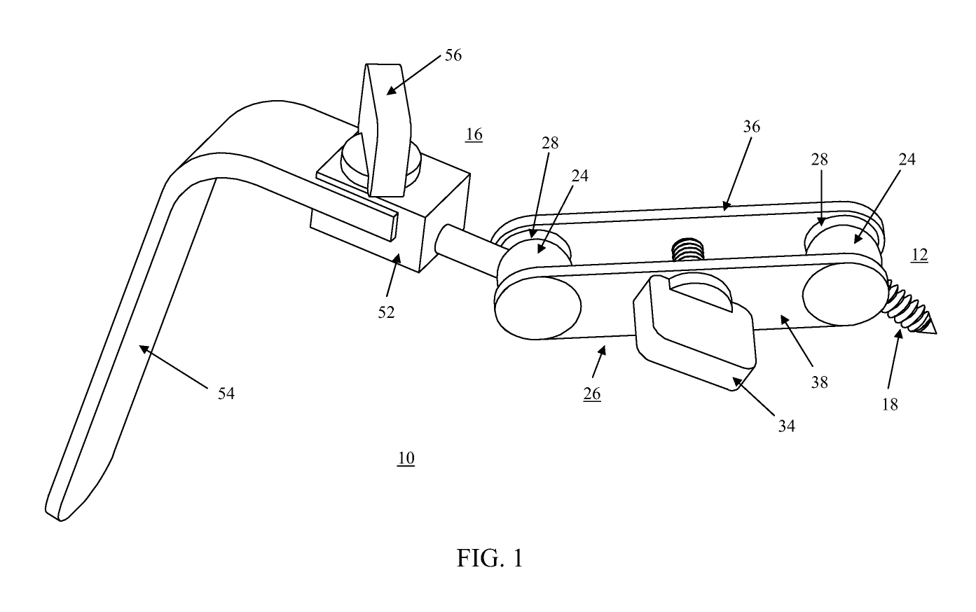

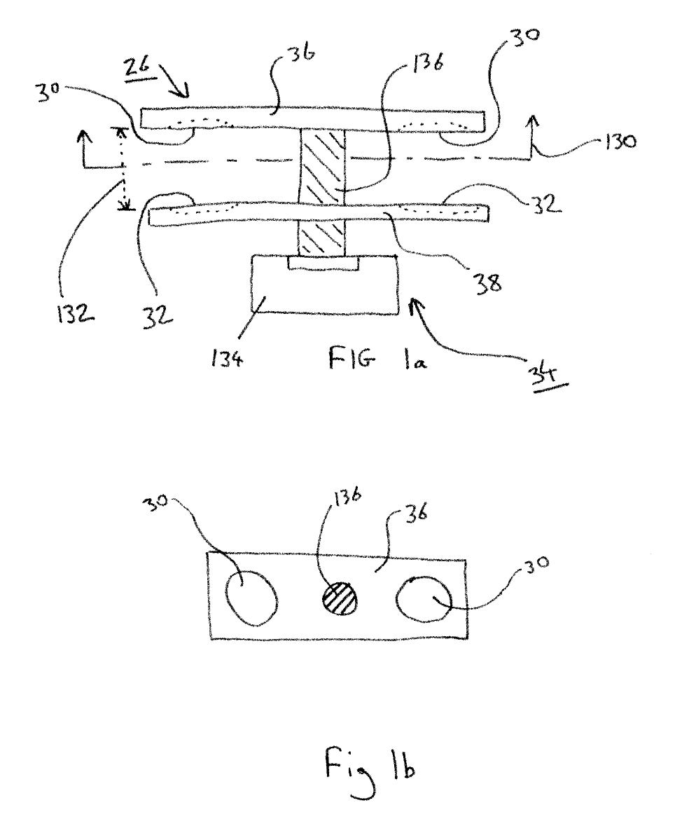

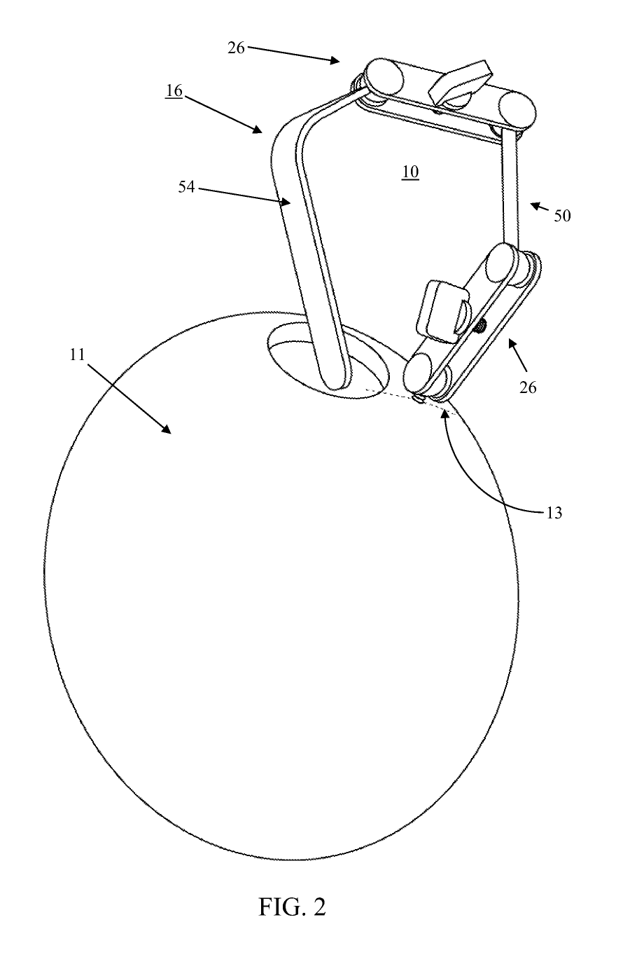

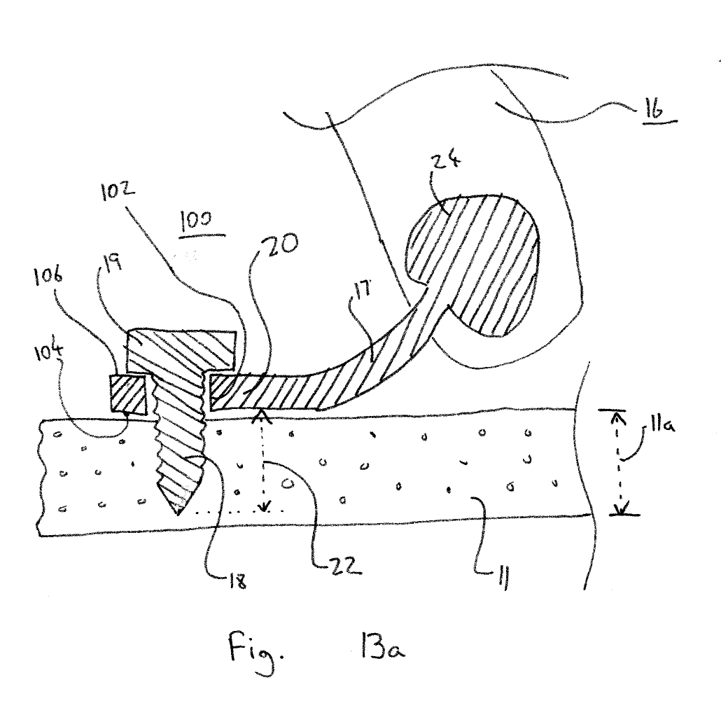

A surgical tool holder 10 is generally comprised of a base member 12, one or more intermediary members, and a tool engaging member 16. One example of a surgical tool holder 10 is shown in FIG. 1. According to the present invention, the base member 12 is attached to the patient's body so as to remain fixed during surgery. For example, the base member 12 may be screwed into the skull 11 of a patient undergoing neurosurgery, as shown in FIG. 2, and a brain retractor 54 at the distal end of surgical tool holder 10 may be inserted in an opening 11a in the skull 11 during surgery. The brain retractor 54 may be connected to the base member 12 through one or more flexibly connected intermediary members, such as a link clamp member 26, a link knob member 50, a tool engaging member 16, a hybrid intermediary member 140, etc., as will be described more fully herein. Alternatively, a surgical tool 54 and tool engaging member 16 may be directly connected to a base member 100, as shown in FIG. 13.

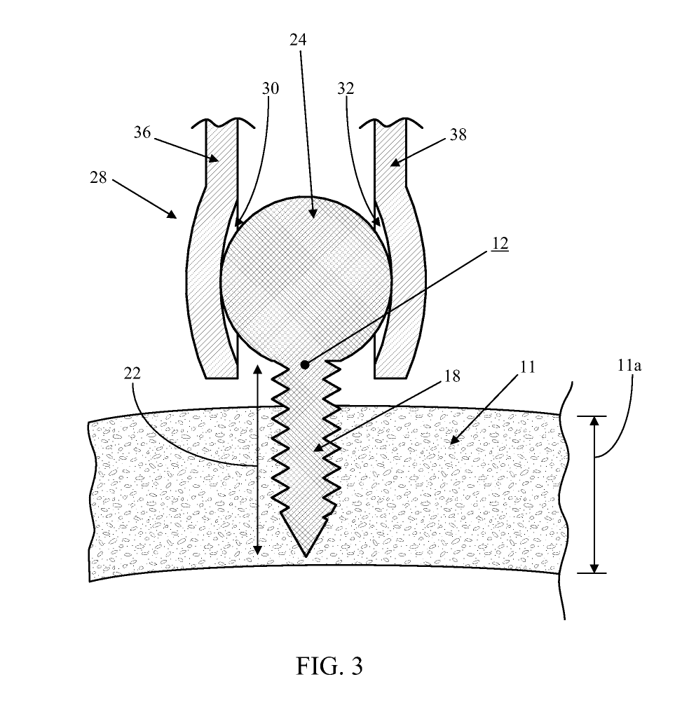

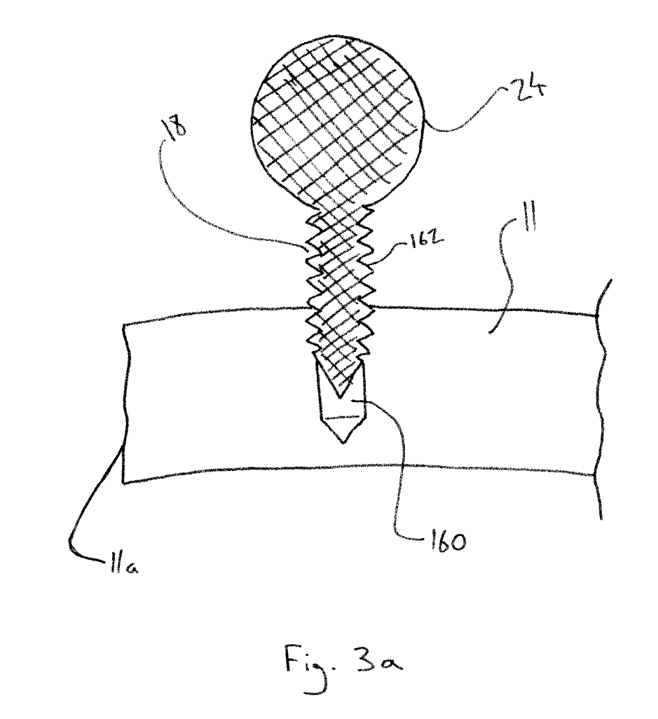

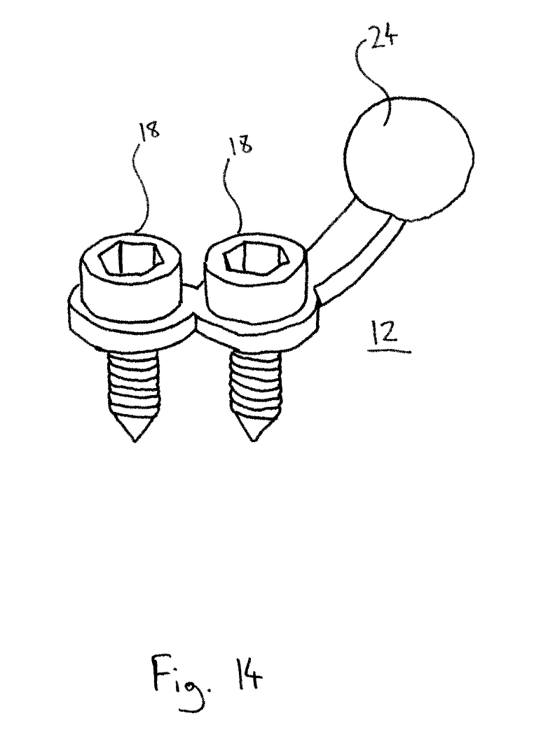

A base member 12, 100 includes a means for fixing the surgical tool holder to the patient's body. In the examples shown in FIGS. 1 and 2, such fixing means is a bone screw 18. The bone screw may be made of, for example, titanium, stainless steel, biocompatible plastic or any other suitable material. The fixing means may also be any other type of screw, a nail, a clamp, two or more bone screws, one or more bone pins, or any other means known in the art for attachment to bone, of which there are many. The geometry of a bone screw may be adapted for a particular type of surgery or for a particular type of bone to which the base member 12 is to be attached. For example, the length 22 of a bone screw 18 may be selected so as to ensure that the bone screw 18 does not pass completely through the patient's skull 11, as shown in FIG. 3, which is a detailed cross section view taken along dashed line 13, shown in FIG. 2. As another example, a width of the screw or a thread profile or style of the screw may be chosen according to the particular type of bone to which the bone screw is intended to be attached. For example, the thread profile of the bone screw may be configured so as to cut or form threads in the bone as it is screwed into place. A bone screw employing such a thread may be referred to as self-tapping or thread-forming. In another example, two or more fixing means may be employed to attach the base member 12 to a patient's body. For example, the base member 12 shown in FIG. 14 is configured for attachment to a patient's body with two bone screws 18.

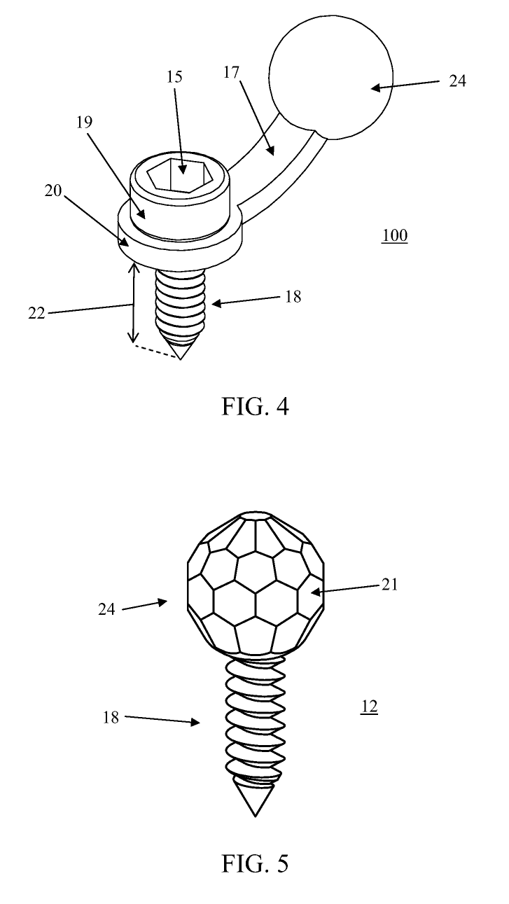

Bone screws suitable for attaching the surgical tool holder 10 of the present invention may require a hole to be pre-drilled in the bone at the site of installation prior to being screwed into place or may be adapted to penetrate bone without the need for a pre-drilled hole. In the example of a self-tapping bone screw, the threads of the bone screw may engage with a pre-drilled hole and cut or form mating threads in the bone as the bone screw is installed, as shown in FIG. 3a. FIG. 3a is a cross section taken along dashed line 13 in FIG. 2 during installation of the bone screw 18 into a pre-drilled hole 160 in the skull 11. As shown, the threads 162 of the bone screw 18 deform or cut the side walls of the pre-drilled hole 160 as the bone screw 18 is twisted into position. Many suitable approaches for installing bone screws are known in the art and may be employed with the present invention. In one example, the bone screw 18 may include an installation feature such as a hex socket 15, shown in FIG. 4, which may be installed with the aid of a hex key or Allen wrench. In other examples, the bone screw 18 may be adapted for installing with a Phillips or flat head screwdriver, an open end or box wrench, a permanent or removable cross bar, a hand or finger operable gripping member, etc. Alternatively, a bone screw 18 may not include any discernable feature to aid in installation, as in the example shown in FIGS. 3 and 3a, for example, but may instead be installed simply by grasping the bone screw 18 or a link attachment knob 24 integrally formed with the bone screw 18 securely with a pair of pliers or similar tool, for example, and twisting the bone screw 18 into position.

The base member 12 may be one piece, as shown in FIGS. 1-3a, or may be comprised of a plurality of parts, as shown, for example, in FIGS. 4, and 11-13a. In the example shown in FIG. 3, the base member 12 may include fixing means such as a bone screw 18 fixedly attached to or formed integrally with a link attachment knob 24, which may be spherical in shape. In this example, the only direct contact of the surgical tool holder 10 with the patient may be through the bone screw 18, as shown in FIG. 3.

In another example, shown in FIGS. 4 and 13a, a cross section taken along dashed line 170 in FIG. 13, a base member 100 may comprise a bone screw 18 and an arm attachment 17. The arm attachment 17 of the base member 100 may include a hole 102 through which the bone screw 18 is inserted and may include a patient contacting portion 20. After installation, the patient contacting portion 20, which may be integral with the arm attachment 17 and link attachment knob 24, is sandwiched securely between the patient's body, for example the skull 11 in FIG. 13a, and a head 19 of the bone screw 18. The patient contacting portion 20 includes a lower surface 104 in contact with the patient's body, for example the skull 11 during neurosurgery as shown in FIG. 13a, and an upper surface 106 in contact with the head 19 of the screw 18. The lower surface 104 in contact with the patient's body may be a plain, smooth surface or may also be textured or otherwise configured to increase grip against the patient's body. For example, the patient contacting surface 20 may include sharp teeth or other features configured to securely fix the arm attachment part 17 to the patient. In the example shown in FIGS. 4 and 13a, the bone screw penetration distance 22, which may be selected to be less than a thickness of the bone that the base member 12, 100 is to be attached to, for example a thickness 11a of the skull 11, is measured from the lower surface 104 of the patient contacting portion 20 to the tip of the bone screw 18. In the example shown in FIGS. 4 and 13 and 13a, the link attachment knob 24 is shown to be fixedly attached to or integrally formed with the arm attachment part 17.

The link attachment knob 24 engages with intermediary members of the surgical tool holder 10. One example of an intermediary member configured to engage with a link attachment knob 24 is a link clamp member 26, shown in FIG. 1, for example. Generally, a link clamp member 26 includes knob engagement sections 28 for adjustably and selectively fixing the link clamp member 26 onto a link attachment knob 24.

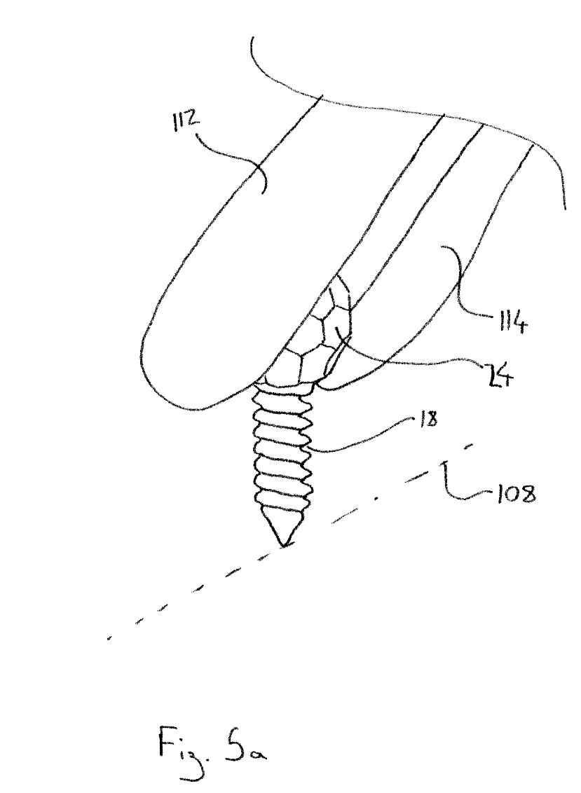

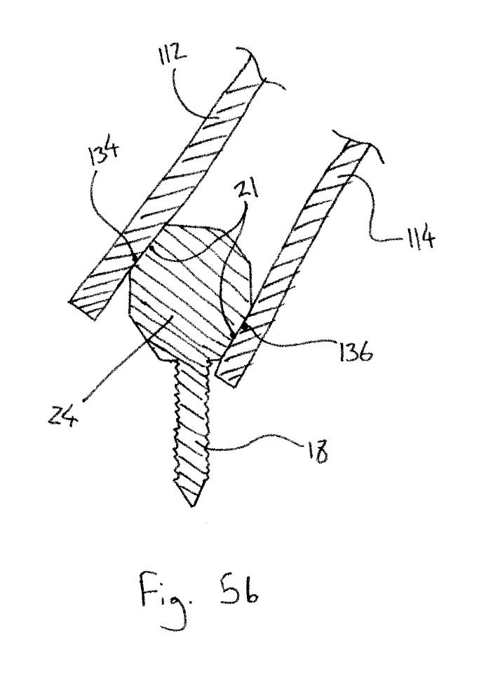

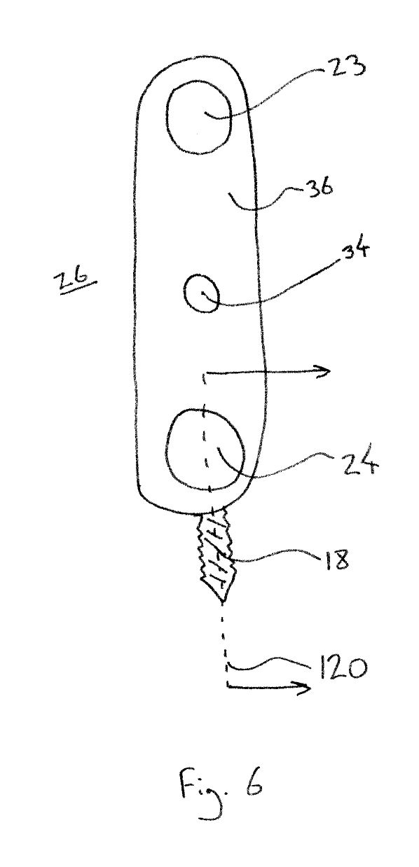

Such link attachment knob 24 may be generally spherical in shape, as shown, for example, in FIGS. 3 and 4, or may be another shape, such as a truncated spherical shape, a circular disc shape, or a shape which includes flat portions. For example, as shown in the example of a base member 12 shown in FIG. 5, the link attachment knob 24 may be shaped with flat or semi-flat facets 21 having sharply defined (as shown) or rounded over edges (not shown) therebetween. Link clamp components 112 and 114, shown in FIG. 5a, for example, may be configured to engage with a faceted link attachment knob 24, like the one shown in FIG. 4, for example, and may each include relatively flat knob engagement portions 134 and 136, as shown in FIG. 5b, a cross section taken along dashed line 108 in FIG. 5a. As shown, flat knob engagement portions 134 and 136 engage with facets 21 of the link attachment knob 24 to provide one or more pre-determined and discrete fixation orientations between the link attachment knob 24 and the link clamp member 26.

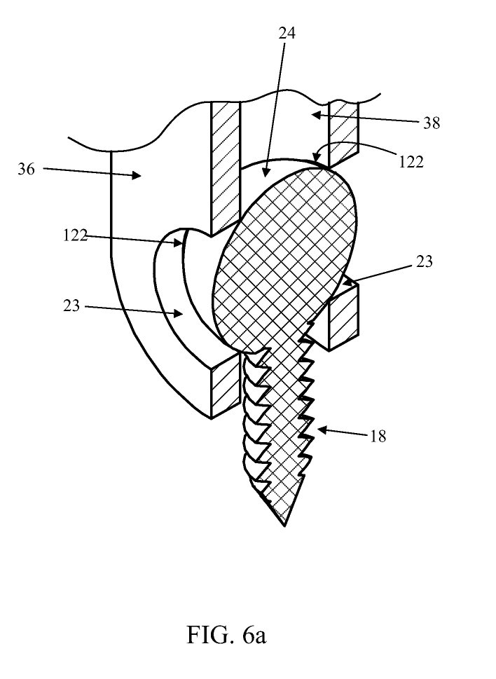

Knob contacting surfaces are not limited in shape. For example, when the link attachment knob 24 includes a spherically shaped portion, as shown in FIGS. 1-3, for example, an unlimited number of fixation positions or degrees of freedom may be provided between the link attachment knob 24 and a link clamp member 26. For example, knob contacting surfaces 30 and 32 may be generally spherical, as shown in FIG. 3, having a radius equal to or larger than a radius of a link attachment knob 24. Alternatively, as shown in FIGS. 6 and 6a, a partial orthogonal cross section view taken along dotted line 120 in FIG. 6, knob contacting surfaces may be formed by inner edge surfaces 122 of through holes 23 in link clamp members 36, 38. As yet another example, shown in FIG. 5a, knob contacting surfaces may include flat sections 134 and 136, for example when configured to mate with a knob 24 having facets 21. In addition, the shape or type of one knob contacting surface may be the same or different than that of a knob contacting surface at an opposite end of the same link clamp component 36 or 38.

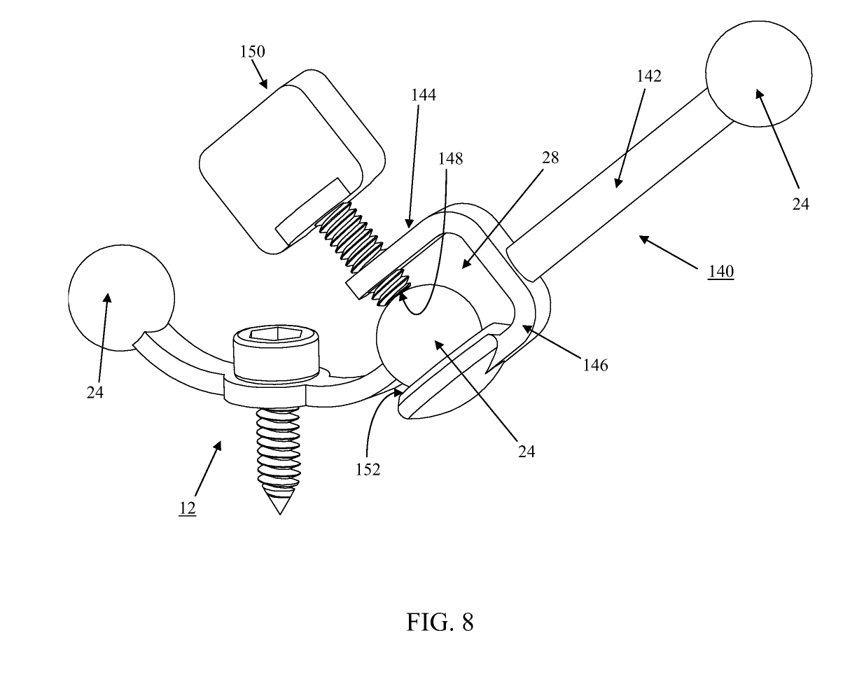

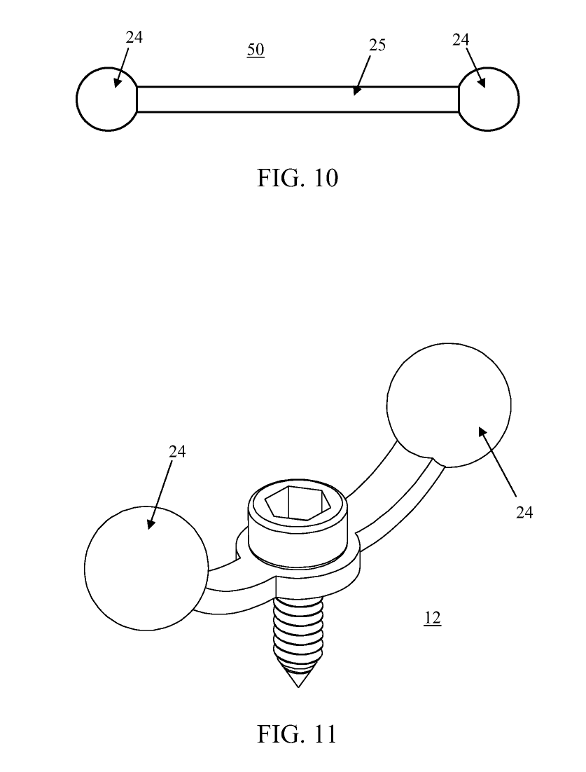

The link attachment knob 24 may be located on the base member 12, at one end of a hybrid intermediary member 140 (FIG. 8) or at one or both ends of a link knob member (FIG. 10). A link knob member 50, shown in FIG. 10, generally includes at least two link attachment knobs 24 and a connecting rod 25 therebetween. It will be appreciated that connecting rod 25 may or may not be cylindrical, and may or may not be straight, and the length and cross sectional profile or area of the link knob member 50 may be selected according to a particular need. The link attachment knobs 24 of the link knob member 50 may be provided at opposite ends thereof. The link attachment knobs 24 of the link knob member 50 may be similar to or different from the link attachment knobs 24 of the base member 12 or the tool holder 16 in shape, size, surface features such as facets, etc. Additionally, one link attachment knob of the link knob member 50 need not be the same the other link attachment knob 24 at the opposite end of the link knob member 50.

One example of a link clamp member 26, shown in FIG. 1, may include two knob engagement sections 28 for engaging with link attachment knobs 24 of a first component, for example base member 12, and a second component, for example tool holder 16, linking them together. The knob engagement sections 28 of the link clamp member 26 may be formed at opposite ends of the link clamp member 26. Knob engagement sections 28 of the link clamp member 26 clamp onto the link attachment knob 24 so as to fix the link clamp member 26 to the link attachment knob 24. In one example, shown in FIG. 3, a knob engagement section 28 includes a first knob contacting surface 30 and a second knob contacting surface 32. The first and second knob contacting surfaces 30 and 32 are pressed together about the knob 24 by turning the turning screw 34 in a clockwise direction so as to force the first knob contacting surface 30 of the first link clamp component 36 towards the second knob contacting surface 32 of the second link clamp member 38 to fix the link clamp member 26 to the knob 24.

In one example, shown in FIG. 1a, a link clamp member 26 may be comprised of a first link clamp component 36 and a second link clamp component 38, separated from the first link clamp component 36 by some distance 132. A fixing means may be configured to press the first link clamp component 36 towards the second link clamp component 38 when a link attachment knob 24 is in engagement with knob contacting surfaces 30, 32. In the example shown in FIGS. 1, 1a and 1b, a cross section taken along dashed line 130 in FIG. 1a, the fixing means may be a turning screw 34. The turning screw 34 may include a grasping portion 134 and a threaded portion 136. The turning screw 34 may be fitted through a hole provided in the second link clamp component 38 and threaded into the first link clamp component 36. Tightening the turning screw 34 biases the first link clamp component 36 toward the second link clamp component 38. As shown, the turning screw 34 may be a thumb screw, which is a screw that is provided with an enlarged head 134 for easier handling by a user's fingers without the need for a screw driver or other torque providing tool.

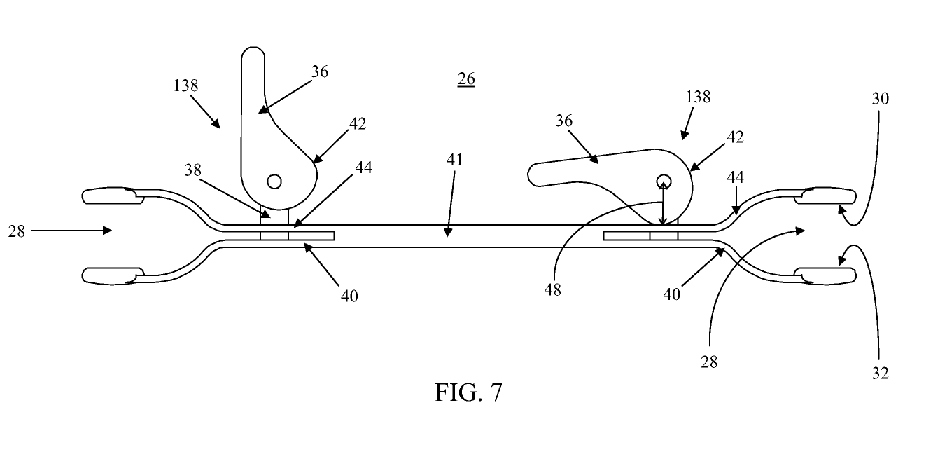

In another example, shown in FIG. 7, link clamp member 26 may comprise a solid mid section 41 which splits into an upper prong 44 and a lower prong 40 at one or both ends. A first knob contacting surface 30 is provided at the end of the upper prong 44 and a second knob contacting surface 32 provided at the end of the lower prong 40. The upper prong 44 and lower prong 40 are attached to one another but are also able to flex relative to one another, i.e. in a configuration similar to a tuning fork. The link clamp member 26 includes an alternative fixing means 138 to bias the first knob contacting surface 30 towards the second knob contacting surface 32 to engage a link attachment knob 24 in knob engagement section 28.

In the example shown in FIG. 7, the fixing means 138 may include a cam toggle lever 36 to bias the first knob contacting surface 30 towards the second knob contacting surface 32. The fixing means 138 may include a cam toggle lever 36 rotatedly mounted to a pin 38 fixed to a the lower prong 40, a cam surface 42 on the lever 36, and a cam bearing surface on the upper prong 44 of a second component 44 upon which the cam surface 42 acts. As the lever 36 is rotated, the cam surface 42 forces the upper prong 44 downwards as a cam radius 48 of the particular point of the cam surface 42 in contact with the cam bearing surface of the upper prong 44 is increased. Such cam toggle lever 36 may be provided with an over-center feature which provides some degree of security to the compression once fully engaged. In such an example, the cam radius 48 may be slightly decreased at a point along the cam surface 42 in contact with the cam bearing surface of the upper prong 44 when the lever is intended to be near a fully engaged position. Thus, additional force is needed to be added in order to release the lever 34 from the fully engaged position.

In yet another example, shown in FIG. 8, a hybrid intermediate member 140, another example of an intermediate member, is comprised of a shaft 142, link attachment knob 24, at one end, and prongs 144 and 146 at the other end. The prongs 144, 146 are similar to the end of the first link clamp component 36 and the opposing end of the second link clamp component 38 of the link clamp member 26. Upper prong 144 has a threaded hole engaged with knob screw 150. Lower prong 146 has a knob contacting surface 152, which in FIG. 8 is not shown but is spherically concave as one example so as to mate with a spherical link attachment knob 24. In this example, the knob screw 150 may be tightened relative to the opposing knob contacting surface 152 in order to press the tip 148 of the knob screw 150 against the link attachment knob 24, with is then biased against the knob contacting surface 152 so as to fix the hybrid intermediate member 140 relative to the base member 12. It will be appreciated that a faceted link attachment knob 24, such as the example shown in FIG. 5, may be employed together with a knob screw 150 having a flat surface at the tip 148 of the knob screw 150, the flat tip surface engaging with a facet 21 of the faceted link attachment knob 24 to provide one or more pre-determined and discrete fixation orientations between the faceted link attachment knob 24 and the hybrid intermediate member 140.

In any of the above examples in which the tip of a knob screw 150 contacts the link attachment knob 24, the tip 148 of the knob screw 150 may be specially adapted for contacting a link attachment knob 24. For example, as shown in FIG. 8a, the tip 148 of a knob screw 150 may be provided with a rotatable portion 154 capable of contacting a link attachment knob 24 and remaining in a fixed rotational position relative to the link attachment knob 24 as the knob screw 150 is tightened. Such rotatable portion 154 may be captively attached to the end of the threaded portion 156 of the knob screw 150, for example by a crimped flange, but is allowed to freely rotate relative to the threaded portion of the knob screw 150. In this case, as the knob screw 150 is tightened, the threaded portion 156 rotates about a longitudinal axis while the rotatable portion 154 does not. In another example, the tip 148 of the knob screw 150 may be made of a different material than the rest of the knob screw 150. For example, a tip 148 of a knob screw 150 may be made of a polymeric material while a threaded portion 156 of the knob screw 150 may be made of metal. In such an example, marring of the link attachment knob 24 by the knob screw 150 may be prevented.

Opposing knob engagement sections 28 of a link clamp member 26 may be provided with a common fixing means (34 in FIG. 1) or may be provided with separate fixing means (138 in FIG. 7). In other words, both knob engagement sections 28 may be fixed simultaneously to link attachment knobs 24 in engagement therewith, as in the example shown in FIG. 1, or the opposing engagement sections 28 at one end of the link clamp member 26 may be fixed to a link attachment knob 24 independent of the opposing engagement sections 28 at the opposite end of the link clamp member 26, as in the example shown in FIG. 7. It will be appreciated that each configuration has its benefits and drawbacks, and may be appropriately selected according a particular situation. For example, in an example in which both ends of a link clamp member 26 may be fixed together, set-up speed may be increased, but possibly at the expense of easy precise positioning of the various components of the surgical tool holder 10. As another example, in an example in which engagement sections 28 of a link clamp member 26 are independently fixable, precision of set-up is increased, but possibly at the cost of increased set-up time. Accordingly, in an example in which a surgical tool holder 10 comprises two or more link clamp members 26, a link clamp member 26 closer to the base member 12 may be provided with fixation means for fixing both knob engagement sections 28 at the same time while a link clamp member 26 closer to the tool engagement member 16 may include independent fixation means for fixing each knob engagement section 28 independently. In this example, the concerns of precision and set-up time may be optimized. In yet another example, shown in FIG. 8, a hybrid intermediary member 140 may be provided with a link attachment knob 24 at one end and a knob engagement section 28 at an opposite end.

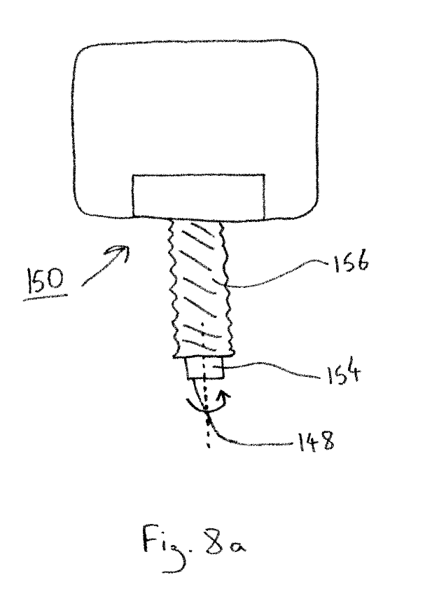

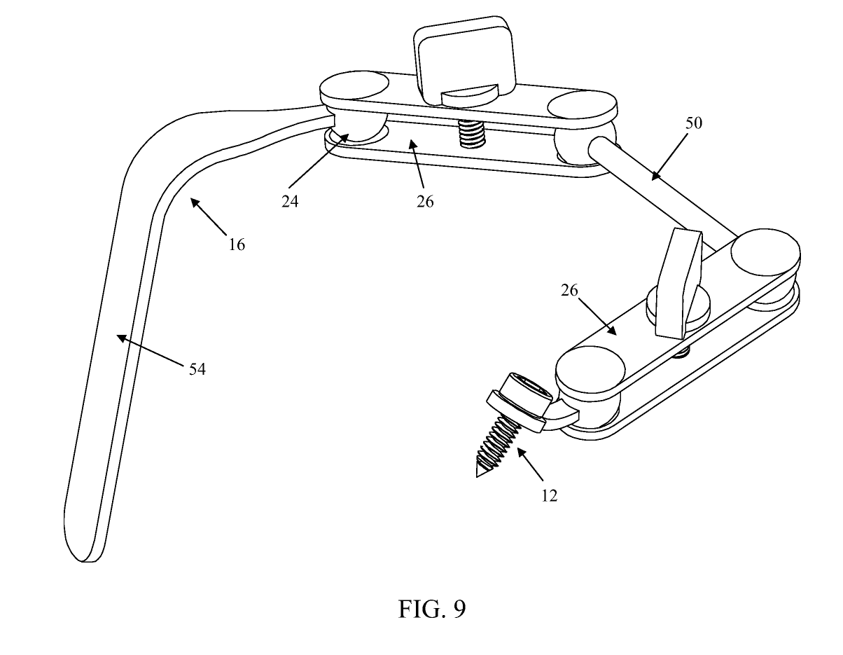

In an example of a surgical tool holder 10 that includes two or more link clamp members 26, such as the example shown in FIGS. 2 and 9, a link knob member 50, another example of an intermediary member, is provided for joining two adjacent link clamp members 26. In such an example, the various members of the surgical tool holder 10 form a chain, generally with the base member 12 at one end, a tool engagement member 16 at the other end, and link clamp members 26, link knob members 50 and/or hybrid intermediary members 140 between.

An example of a tool engaging member 16, shown in FIG. 1, includes a tool engagement section 52 and a link attachment knob 24. The link attachment knob 24 may be the same or different than the link attachment knob 24 of the base member 12 or of any link clamp members 26. The tool engagement section 52 may be adapted for engagement with a particular tool or implement intended to be used with the surgical tool holder 10. For example, the surgical tool holder 10 may be configured for engaging with a retractor tool 54. Such retractor tool may be provided with a threaded portion configured to engage with a complimentary threaded portion provided on the tool engagement section of the tool engaging member, as known to a person of ordinary skill in the art. In another example, shown in FIG. 1, the tool engagement section 52 may be configured to clamp the tool 54 in place. In the example shown in FIG. 1, a tool engaging member 52 is provided with a clamping screw 56 forcibly engaged with the tool 54. As yet another example, the tool 54 may include a knob engagement section or a link attachment knob 24, as shown in FIGS. 2 and 9. Of course, it will be appreciated that the surgical tool holder 10 may be particularly configured to engage with any number of other surgical tools or implements or may be configured with a tool engagement section adapted to engage with any of a plurality of surgical tools.

When assembled, the link attachment knobs of the various components may engage with engagement sections of one or more link clamp members. The engagement sections of the link clamp members may be sequentially fixed to the respective link attachment knobs in order to make the entire surgical tool holder rigid in preparation for surgery.

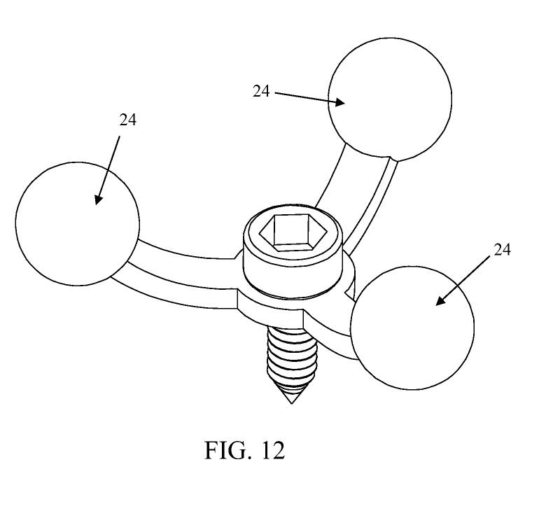

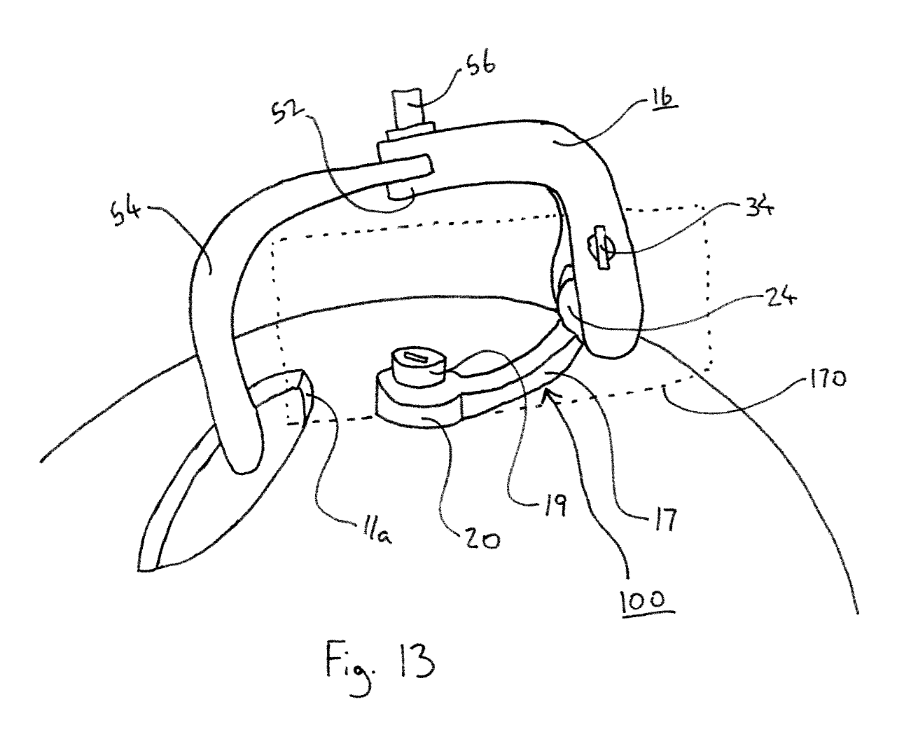

In another embodiment, the base member 12 or a link knob member 50 may be provided with one or more additional link attachment knobs 24. Examples of base members 12 having two link attachment knobs are shown in FIGS. 8 and 11, and an example of a base member 12 having three link attachment knobs 24 is shown in FIG. 12. Such additional link attachment knobs 24 may be used in conjunction with other intermediary members and a tool engagement member 16 to provide a surgical tool holder 10 capable of holding two or more surgical tools at the same time while being fixed to the patient by the single base member.

In yet another embodiment, the base member and tool holder may include knob engagement sections instead of link attachment knobs and one or more link knob members and link clamp members may be employed as intermediary members in a surgical tool holder.

In addition, the embodiments and examples above are illustrative, and many variations can be introduced on them without departing from the spirit of the disclosure or from the scope of the appended claims. For example, elements and/or features of different illustrative and exemplary embodiments herein may be combined with each other and/or substituted for each other within the scope of this disclosure. As one example, two or more tool holders may be attached to a patient's body during surgery to independently hold multiple tools or devices.

What is claimed is:

1. A surgical tool holder comprising:
a tool engaging member having a tool engagement section and a link attachment knob;
at least one intermediary member;
a base member having a link attachment knob and attachment means for attaching the base member to a patient's bone when tightened,
wherein the at least one intermediary member is configured to fixedly or flexibly connect the tool engagement member with the base member.

2. The surgical tool holder of claim 1, wherein the at least one intermediary member includes at least one knob engagement section at and end thereof, the at least one knob engagement section comprising a first knob contacting surface, a second knob contacting surface and a fixing means for pressing the first knob contacting surface towards the second knob contacting surface and
wherein the at least one knob engagement section of the at least one intermediary member is in engagement with the link attachment knob of the tool engaging member, the link attachment knob of a different intermediary member, or the link attachment knob of the base member.

3. The surgical tool holder of claim 1, wherein the base member is not fixed to any other reference point.

4. The surgical tool holder of claim 1, wherein the at least one intermediary member comprises at least one link knob member, each link knob member comprising link attachment knobs at opposite ends thereof,
wherein the surgical tool holder includes at least two link clamp members, the link attachment knobs of the at least one link knob member each being in engagement with knob engagement sections of different link clamp members, the link attachment knob of the tool engagement member and the link attachment knob of the base member being in engagement with knob engagement sections of different link clamp members, and each fixing means of the at least two link clamp members being fixable independently from one another.

5. The surgical tool holder of claim 2, wherein each intermediary member includes a first knob engagement section and a second knob engagement section, wherein the fixing means comprises separate fixing means for each knob engagement section, and wherein each fixing means is independently operable with respect to the other.

6. The surgical tool holder of claim 1, wherein the base member includes two or more link attachment knobs, each link attachment knob of the base member being engageable with different intermediary members.

7. The surgical tool holder of claim 1, further comprising a retractor fixedly attached to the tool engaging member via the tool engagement section of the tool engaging member.

8. The surgical tool holder of claim 1, wherein the base member is configured so that the attachment means is the only point of contact between the base member and the patient's body.

9. The surgical tool holder of claim 1, further comprising a surgical tool, the surgical tool being integrally formed with the tool engagement member.

10. The surgical tool holder of claim 1, further comprising fixing means for selectively fixing at least two engagements simultaneously, the at least two engagements being selected from:
the engagement between the base member and the at least one intermediary member,
the engagement between the tool engaging member and the at least one intermediary member, and
if the surgical tool holder comprises more than one intermediary member, any engagement between adjacent intermediary members.

11. The surgical tool holder of claim 2, wherein the intermediary member is a link clamp member and includes at least two knob engagement sections.

12. The surgical tool holder of claim 2, wherein the intermediary member is a hybrid intermediary member which includes at least one link attachment knob and at least one knob engagement section.

13. The surgical tool holder of claim 2, wherein the at least one intermediary member is a link clamp member and includes a first knob engagement section and a second knob engagement section at opposite ends and the fixing means is configured to press the first knob contacting surface of the first and second knob engagement sections towards the second knob contacting surface of the first and second knob engagement sections, thereby simultaneously fixing the link clamp member to link attachment knobs in engagement with at least one of the first and second knob engagement sections.

14. The surgical tool holder of claim 2 wherein the fixing means is one of a turning screw, a knob screw and a cam toggle lever.

15. The surgical tool holder of claim 2, wherein the fixing means comprises a knob screw and the first knob contacting surface of at least one intermediary member includes the tip of the knob screw.

16. The surgical tool holder of claim 2, wherein the attachment means is one or more bone screws.

17. The surgical tool holder of claim 16, wherein each bone screw of the base member is able to rotate freely with respect to the link attachment knob of the base member during attachment of the surgical tool holder.

18. The surgical tool holder of claim 16, wherein the bone screw of the base member is fixed relative to the link attachment knob of the base member.

19. The surgical tool holder of claim 16, wherein the base member includes a lower patient contacting surface and the bone screw of the base member has a length measured from the lower patient contacting surface to a tip of the bone screw that is selected to be shorter than a thickness of a bone to which the bone screw is attached.

20. The surgical tool holder of claim 16, wherein the link attachment knob of the base member is comprised of a knob component of the base member, the at least one bone screw of the base member is configured to be attachable to a patient's bone without being permanently attached to the knob component and the knob component and at least one bone screw are configured to engage one another after the at least one bone screw is attached to the patient's bone so that the knob component is immobile with respect to the at least one bone screw after the at least one bone screw is attached to the patient's bone.

21. The surgical tool holder of claim 16, wherein the at least one bone screw of the base member is self tapping.

22. A surgical tool holder comprising:
a tool engaging member;
a base member attachable to a patient's bone, the base member comprising at least one link attachment knob;
attachment means for attaching the base member to the patient's bone; and
at least one intermediary member connecting the link attachment knob of the base member to the tool engaging member in a selectively fixable manner, wherein
engagements between the base member and the at least one intermediary member and between the tool engaging member and the at least one intermediary member are selectively fixable.

23. The surgical tool holder of claim 22, wherein the attachment means is one or more bone screws which penetrates at least a portion of the patient's bone.

24. The surgical tool holder of claim 22, wherein at least one of the at least one intermediary members is a hybrid intermediary member that includes a link attachment knob at a first end and a knob engagement section at an opposite end configured to engage with a link attachment knob in a selectively fixable manner.

25. A surgical tool holder comprising:
a tool engaging member including a knob engagement section;
a base member attachable to a patient's bone, the base member comprising at least one link attachment knob; and
attachment means for attaching the base member to the patient's bone, wherein
the knob engagement section of the tool engaging member is engaged with the link attachment knob of the base member and
the engagement between the base member and the tool engaging member is selectively fixable.
